(19) United States
(12) Patent Application Publication
(10) Pub. No.: US 2010/0182558 A1
(43) Pub. Date: Jul. 22, 2010

(54) LIQUID CRYSTAL DISPLAY PANEL

(75) Inventors: Ying Chi Lu, Hsin-Chu (TW); Ming Chun Li, Hsin-Chu (TW); Hong Ji Huang, Hsin-Chu (TW); Seok Lyul Lee, Hsin-Chu (TW)

Correspondence Address: WPAT, PC;INTELLECTUAL PROPERTY ATTORNEYS, 2030 MAIN STREET, SUITE 1300, IRVINE, CA, 92614, US

(73) Assignee: AU OPTRONICS CORPORATION, Hsin-Chu (TW)

(21) Appl. No.: 12/691,442

(22) Filed: Jan. 21, 2010

(30) Foreign Application Priority Data
Jan. 22, 2009 (TW) 098102374

(51) Int. Cl. G02F 1/1343

(52) U.S. Cl. 349/141

(57) ABSTRACT

According to the present invention, an LCD panel includes a first substrate, a second substrate placed opposite to the first substrate, and a liquid crystal layer placed between the first substrate and the second substrate. The first substrate includes a pixel electrode and a first common electrode. The pixel electrode includes a plurality of first protruding nodes, and the first common electrode includes a plurality of second protruding nodes interleaved with the plurality of first protruding nodes. The second substrate includes a second common electrode corresponding to the first common electrode. The second common electrode includes a plurality of third protruding nodes corresponding to the second protruding nodes.

### BACKGROUND OF THE INVENTION

(A) Field of the Invention

The present invention relates to a display apparatus, and more specifically, to a liquid crystal display (LCD) panel.

(B) Description of Related Art

Liquid crystal displays (LCD) have many advantages such as thin profile, light weight, low power consumption and low radiation, and therefore are widely used in currently developing display applications such as monitors, notebook computers, digital cameras and projectors.

For a traditional super-twisted nematic (STN) crystal display panel, the pixel electrode is disposed on a lower substrate, and a common electrode is disposed on an inner surface of an upper substrate. Accordingly, most of the liquid crystals are driven in vertical direction, inducing the disadvantage of a narrow view angle. Such display panels are not suitable for large panel applications.

Recently, an In-Plane-Switching (IPS) liquid crystal display panel with a wide view angle has been proposed. As shown in FIG. 1, an IPS LCD panel 10 includes a lower substrate 11 and an upper substrate 12. A pixel electrode 13 and a common electrode 14 are disposed on the lower substrate 11, and are interlaced as a comb-electrode. Because the IPS LCD panel 10 uses a lateral electrical field, some of the liquid crystals are rotated in an approximately horizontal direction. As a result, the problem of narrow view angle caused by viewing at different angles can be resolved, and thus the IPS LCD panel exhibits wide view angle behavior.

The IPS LCD panel has wide view angle feature; however, the electrical field generated between the pixel electrode 13 and the common electrode 14 cannot rotate the liquid crystals above the pixel electrode 13 and the common electrode 14 due to the lateral electrical field design. Therefore, the light penetration rate is decreased.

### SUMMARY OF THE INVENTION

To resolve the above problems, the present invention proposes an improved LCD panel. By improving the electrode contour, in addition to increasing the light penetration rate, the threshold voltage of the LCD panel can be lowered, thereby significantly improving the display characteristics of the panel.

According to the present invention, an LCD panel includes a first substrate, a second substrate placed opposite to the first substrate, and a liquid crystal layer placed between the first substrate and the second substrate. The first substrate includes a pixel electrode and a first common electrode. The pixel electrode includes a plurality of first protruding nodes, and the first common electrode includes a plurality of second protruding nodes. The plurality of first protruding nodes and the plurality of second protruding nodes are staggered relative to each other in an interleaved manner. The second substrate includes a second common electrode corresponding to the first common electrode. The second common electrode includes a plurality of third protruding nodes corresponding to the second protruding nodes.

In an embodiment, the pixel electrode, the first common electrode and the second common electrode are comb-shaped structures, and the first protruding nodes, the second protruding nodes and third protruding nodes are included in the electrode branches. Each of the protruding nodes includes an electrode portion and a pair of bulges protruding from the electrode portion. The bulges of the pixel electrodes and the bulges of the first or second common electrode are staggered relative to each other in an interleaved manner.

The protruding nodes of the present invention can be in the form of a round shape or a polygon such as hexagon, diamond or the like.

In a further embodiment, the second substrate further includes a floating electrode interlaced with the second common electrode. Viewed from above, the floating electrode corresponds to the pixel electrode of the first substrate.

### BRIEF DESCRIPTION OF THE DRAWINGS

FIG. 1 is a known IPS LCD panel structure;

FIG. 2 is a top view of an LCD panel in accordance with an embodiment of the present invention;

FIG. 3 is the cross-sectional view along line 1-1 of FIG. 2;

FIG. 4 is a top view of assembling an LCD panel in accordance with an embodiment of the present invention;

FIGS. 5 and 6 show the arrangements of the pixel electrode and the common electrode of the LCD panel in accordance with another embodiment of the present invention;

FIG. 7 shows penetration rate distribution of the LCD panel in accordance with an embodiment of the present invention;

FIG. 8 shows a cross-sectional view of the LCD panel in accordance with another embodiment of the present invention;

FIG. 9 shows the diagram of the relation of voltage and penetration rate in accordance with an embodiment of the present invention;

FIGS. 10 and 11 show the arrangements of the pixel electrodes and the common electrodes of the LCD panel in accordance with other embodiments of the present invention.

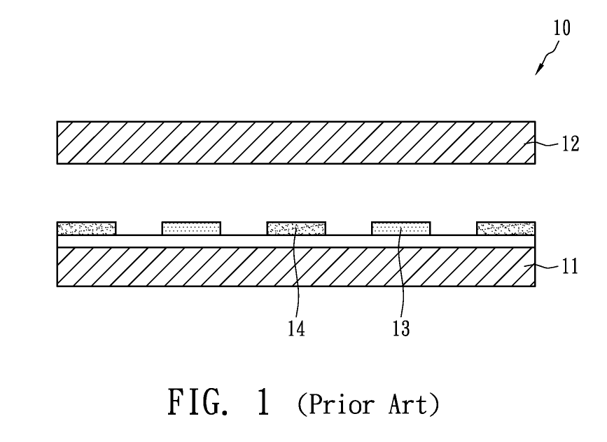

### DETAILED DESCRIPTION OF THE INVENTION

The making and use of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

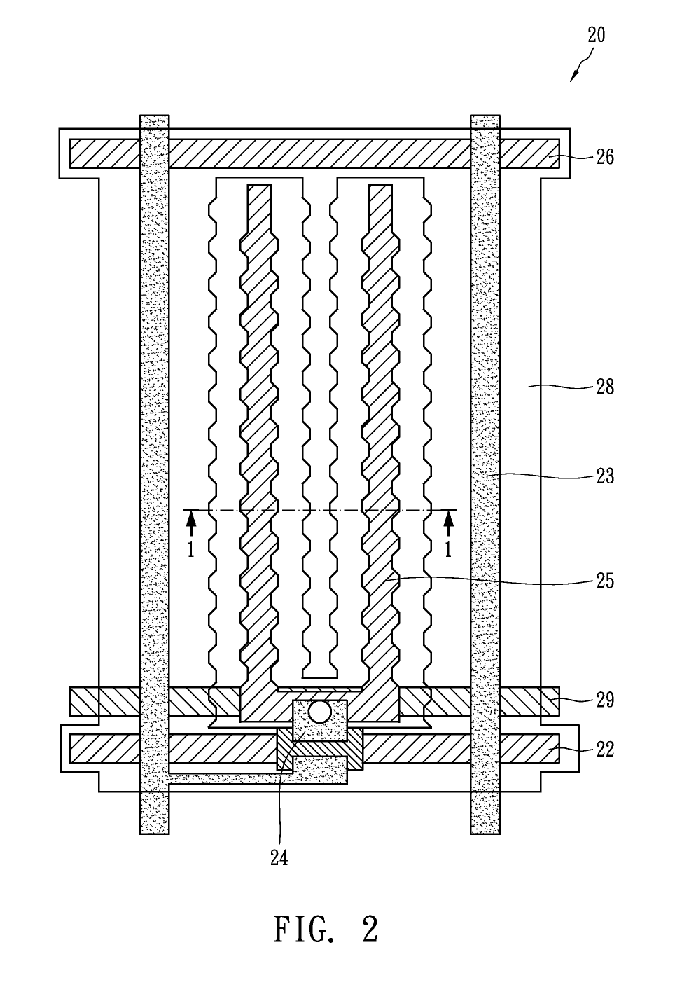

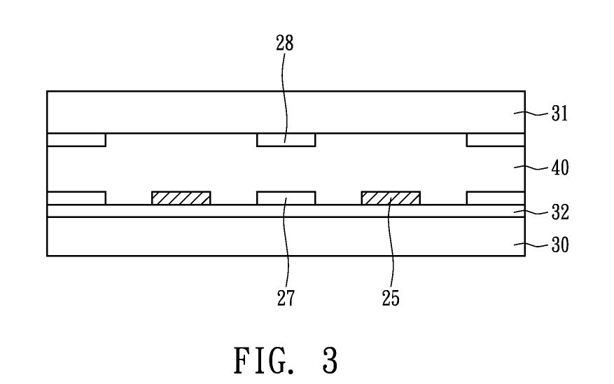

FIG. 2 is a top view of the LCD panel in accordance with an embodiment of the present invention. FIG. 3 is a cross-sectional view of line 1-1 of FIG. 2. An LCD panel 20 includes a first substrate 30, a second substrate 31 and a liquid crystal layer 40. The first substrate 30 and the second substrate 31 are opposite to each other. The liquid crystal layer 40 is disposed between the first substrate 30 and the second substrate 31. In a pixel cell of the LCD panel 20, a scan line (gate line) 22 and a data line 23 extend laterally and longitudinally, respectively, and are interlaced. The data line 23 is coupled to the pixel electrode 25 through the thin-film transistor (TFT) 24, and the scan line 22 is also connected to the TFT 24 to control open or short of the TFT 24. The above devices are usually placed on an insulation layer 32 over the first substrate 30 (such as a thin film transistor (TFT) array substrate). A color filter and a black matrix are usually placed on the second substrate 31 (such as a color filter array substrate), but not limited thereto.

The insulation layer 32 of the first substrate 30 (e.g., TFT array substrate) is opposite to the second substrate 31. The pixel electrode 25 and a first common electrode 27 are disposed on the insulation layer 32 of the first substrate 30. A second common electrode 28 is disposed on an inner side of the second substrate 31 (e.g., color filter array substrate) that is opposite to the first substrate 30, and corresponds to the first common electrode 27. The first common electrode 27 and the data line 23 form a storage capacitor. Optionally, a common electrode line 29 may be formed in the pixel cell, and the common electrode line 29 may be parallel to the scan line 22. Accordingly, a part of the common electrode line 29 and a part of the pixel electrode 25 are overlapped to form a storage capacitor.

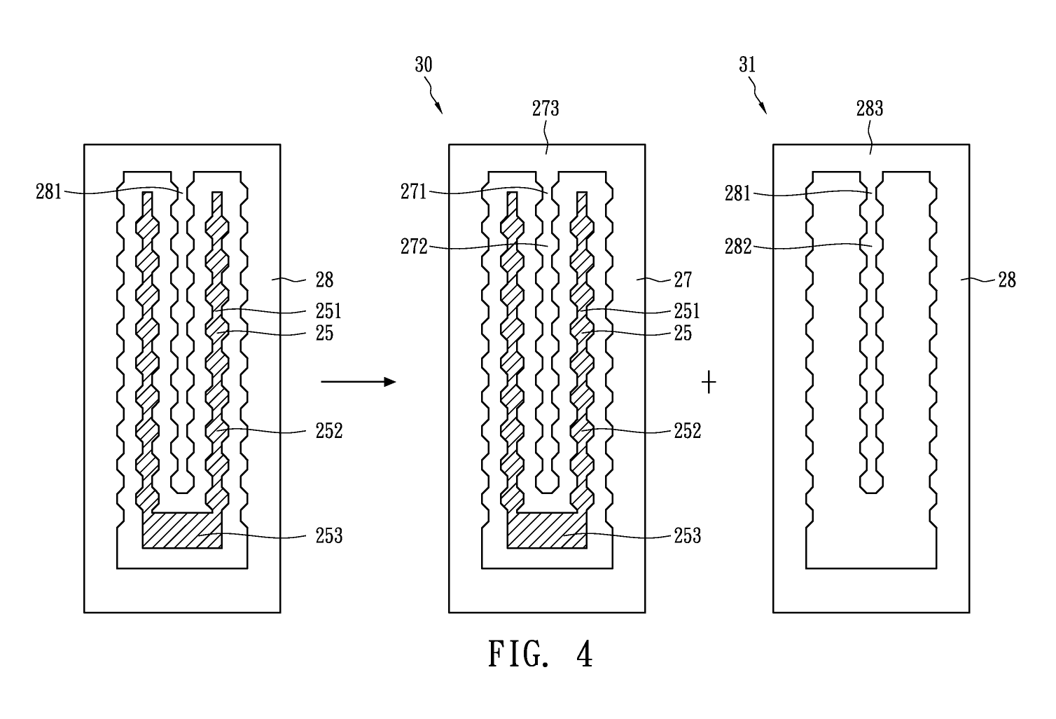

Referring to FIG. 4, with a top view, the LCD panel is a stack of the pixel electrode 25 and the first common electrode 27 of the first substrate 30 and the second common electrode 28. More particularly, the pixel electrode 25 includes a plurality of first electrode branches 251 that may extend longitudinally, and each of the first electrode branches 251 includes a plurality of first protruding nodes 252. The pixel electrode 25 may further include a connection portion 253 connecting the first electrode branches 251. The first common electrode 27 includes a plurality of second electrode branches 271 that may extend longitudinally, and each of the second electrode branches 271 includes a plurality of second protruding nodes 272. The first common electrode 27 may further include a first electrode line 273 connecting the second electrode branches 271 of the neighboring pixel cells. The second common electrode 28 includes a plurality of third electrode branches 281 that may extend longitudinally, and each of the third electrode branches 281 includes a plurality of third protruding nodes 282. The second common electrode 28 may further include a second electrode line 283 connecting the third electrode branches 281 of the neighboring pixel cells.

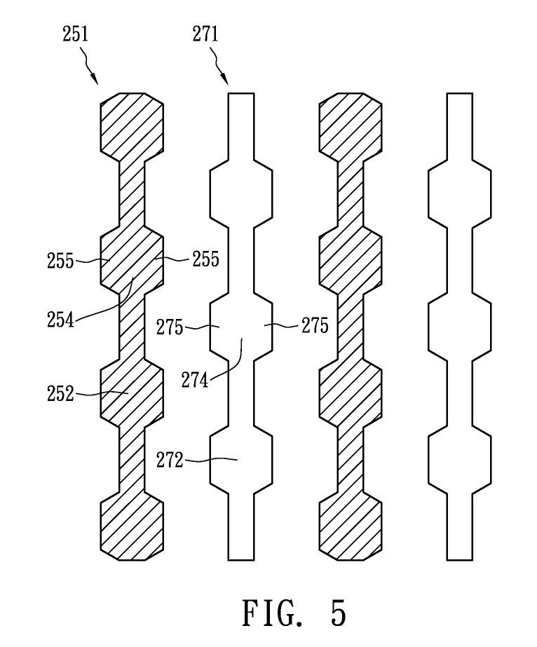

At the detail level, the pixel electrode 25, the first common electrode 27 and the second common electrode 28 are structures including protruding nodes. FIG. 5 shows the top view of the arrangement of the first electrode branches 251 of the pixel electrode 25 and the second electrode branches 271 of the first common electrode 27. The first protruding nodes 252 and the second protruding nodes 272 are interleaved. Each of the first protruding nodes 252 includes a first electrode portion 254 and a pair of first bulges 255 protruding from the first electrode portion 254. Each of the second protruding nodes 272 includes a second electrode portion 274 and a pair of second bulges 275 protruding from the second electrode portion 274. The first bulges 255 of the first protruding nodes 252 and the second bulges 275 of the second protruding nodes 272 are staggered relative to each other in an interleaved manner.

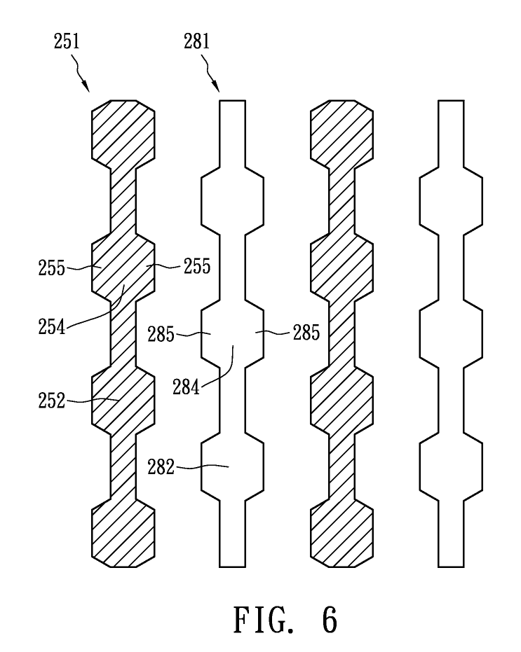

FIG. 6 shows the top view of the arrangement of the first electrode branches 251 of the pixel electrode 25 and the third electrode branches 281 of the second common electrode 28. Because the second common electrode 28 corresponds to the first common electrode 27, the arrangement of FIG. 6 is similar to that shown in FIG. 5. Each of the third protruding nodes 282 includes a third electrode portion 284 and a pair of third bulges 285 protruding the third electrode portion 284. Viewed from above, the first bulges 255 of the first protruding nodes 252 and the third bulges 285 of the third protruding nodes 282 are staggered relative to each other in an interleaved manner.

In this embodiment, the protruding nodes are hexagonally shaped. Due to the staggered arrangement of the first bulges 255 and the second bulges 275, the top surfaces of the hexagonal first bulges 255 of the first protruding nodes 252 do not directly align with the top surfaces of the hexagonal second bulges 275 of the second protruding nodes 272. Likewise, the top surfaces of the hexagonal first bulges 255 of the first protruding nodes 252 do not directly align with the top surfaces of the hexagonal third bulges 285 of the third protruding nodes 282.

The electrode branches of a traditional IPS LCD panel are in the form of strips without protruding nodes, and therefore the electrical field of the pixel electrode and the common electrode is in a single horizontal direction. According to the present invention, the first bulges 255 are interleaved with the second bulges 275 and the third bulges 285. As a result, oblique electrical fields are generated between the first bulges 255 and the second bulges 275, and between the first bulges 255 and the third bulges 285, thereby changing the direction of the liquid crystals in the location of the oblique electrical field and increasing light penetration rate.

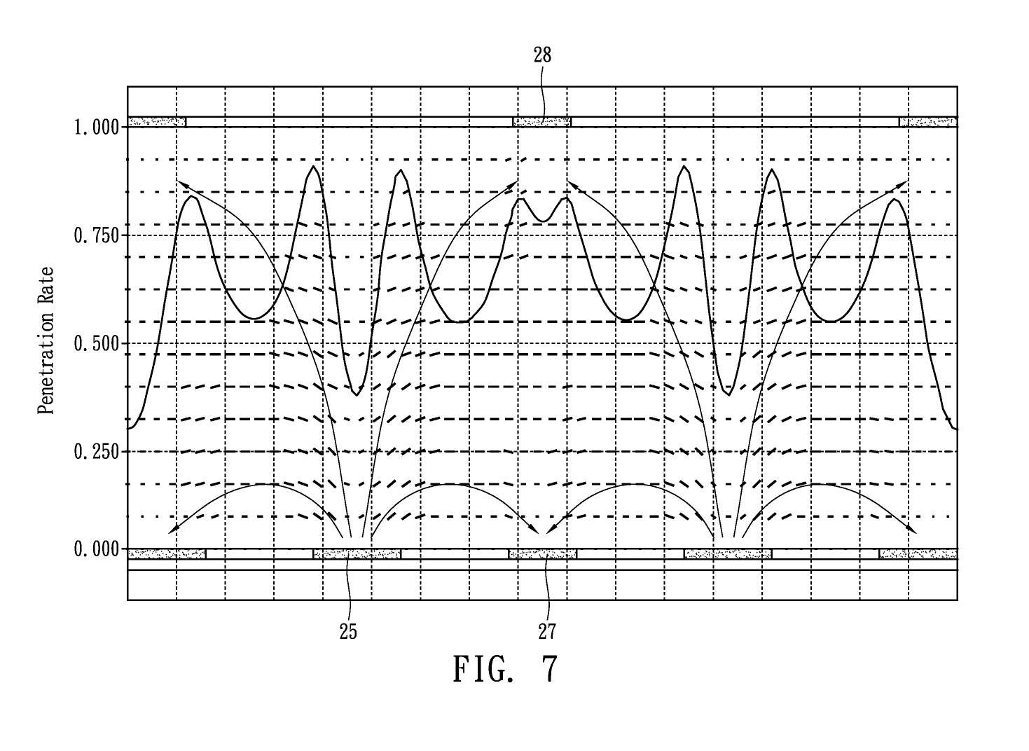

FIG. 7 shows the penetration rate and the electrical field distribution diagram for the LCD panel 20. The common electrodes 27 and 28 are disposed at an upper position and a lower position, respectively, according to the above embodiments; thus lateral electrical fields are generated between the pixel electrode 25 and the first common electrode 27, and oblique electrical fields are generated between the pixel electrode 25 and the second common electrode 28. The directions of the lateral electrical fields and the oblique electrical fields are indicated by arrow signs. In comparison with IPS LCD panel structure, the second common electrode 28 is further added to the second substrate 31 to generate the oblique electrical fields. Accordingly, the liquid crystals at the corresponding positions change the directions complying with the oblique electrical fields, thereby increasing the penetration rate of the LCD panel.

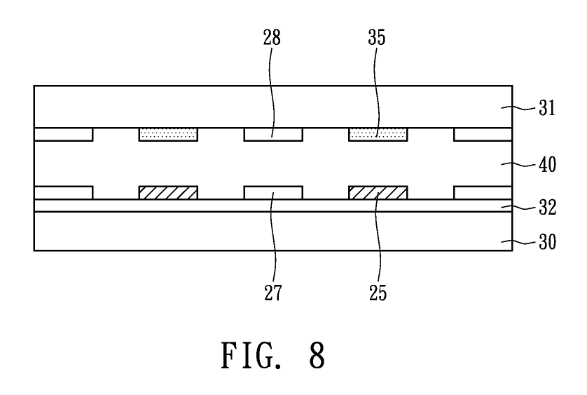

In addition, FIG. 8 shows a cross-sectional view of an LCD panel in accordance with another embodiment of the present invention. In comparison with FIG. 3, in FIG. 8 a floating electrode 35 is further disposed at a position corresponding to the pixel electrode 25. The floating electrode 35 has voltage due to the coupling effect, and thus the floating electrode 35 and the pixel electrode 25 have a voltage difference thereby further increasing the penetration rate of the LCD panel. In an embodiment, the shape of the floating electrode 35 is the same as that of the pixel electrode 25, and when viewed from above the floating electrode 35 is aligned with the pixel electrode 25 and is interleaved with the second common electrode 28.

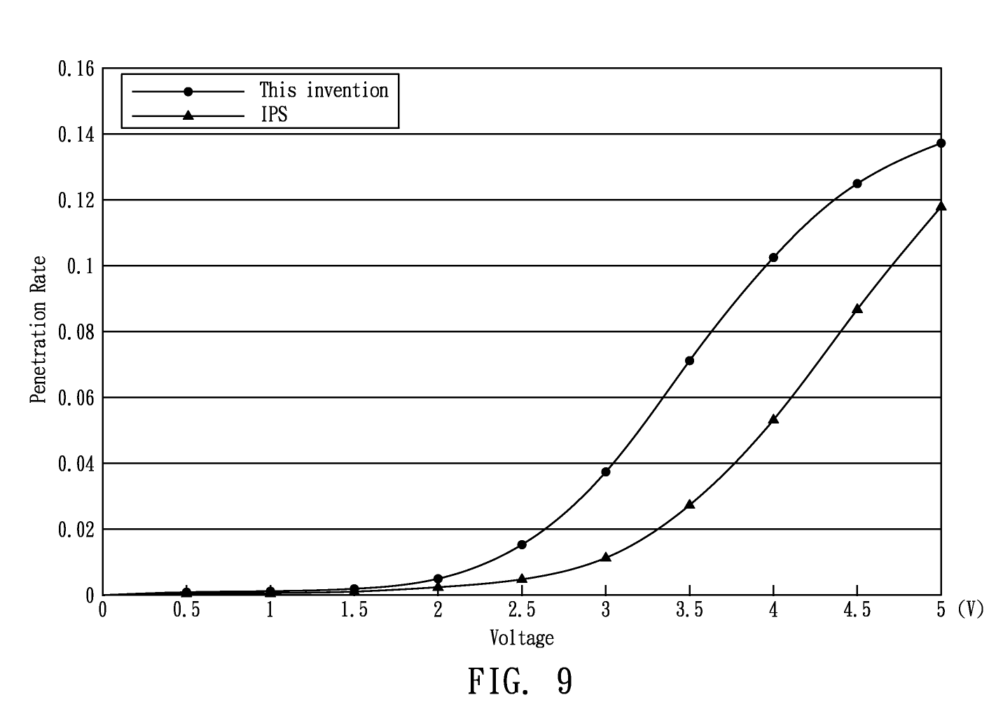

FIG. 9 shows the relationship of the penetration rate and driving voltage of a known IPS LCD panel and the LCD panel of the present invention. In FIG. 9, the initial threshold voltage of the LCD panel of the present invention is lower, so that it has a lower operation voltage. With the same driving voltage, the LCD panel has a high penetration rate in comparison with the IPS panel. By improving the shape of the electrodes, the LCD panel of the present invention has a higher penetration rate and a lower operation voltage, and retains a wider view angle.

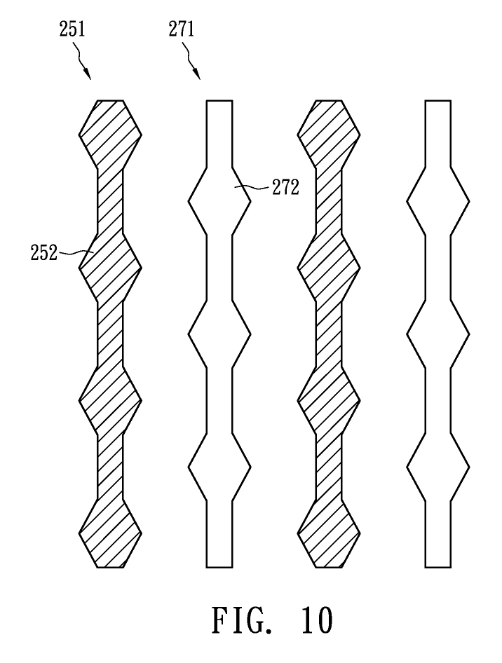

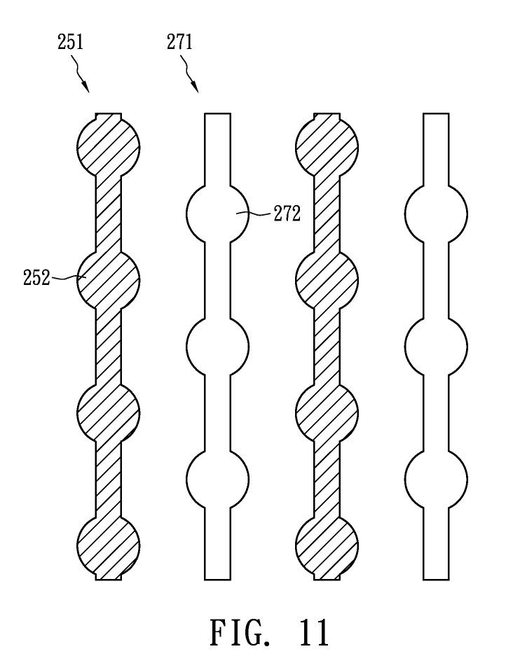

In practice, the first protruding nodes 252, the second protruding nodes 272 and the third protruding nodes 282 can be in the form of polygons such as an arbitrary quadrangle or a round shape. For example, in addition to the hexagon, the protruding nodes may be in the form of a diamond or a round shape. Because the lower first common electrode 27 corresponds to the upper second common electrode 28, viewed from above the common electrodes 27 and 28 are at the same position with reference to the pixel electrode 25. Therefore, the pixel electrode 25 and the first common electrode 27 are illustrative only for explanation, which includes first protruding nodes 252 of the first electrode branches 251 and the second protruding nodes 272 of the second electrode branches 271 as shown in FIG. 10 and FIG. 11.

The above-described embodiments of the present invention are intended to be illustrative only. Numerous alternative embodiments may be devised by those skilled in the art without departing from the scope of the following claims.

What is claimed is:

1. A liquid crystal display (LCD) panel, comprising:
a first substrate, comprising:
a pixel electrode comprising a plurality of first protruding nodes; and
a first common electrode comprising a plurality of second protruding nodes, the first protruding nodes and the second protruding nodes being staggered relative to each other in an interleaved manner;
a second substrate disposed opposite to the first substrate, comprising:
a second common electrode opposite to the first common electrode, the second common electrode comprising a plurality of third protruding nodes corresponding to the second protruding nodes; and
a liquid crystal layer disposed between the first substrate and the second substrate.

2. The LCD panel of claim 1, wherein the pixel electrode comprises a plurality of first electrode branches extending along a first direction, and each of the first electrode branches comprises the first protruding nodes.

3. The LCD panel of claim 2, wherein the pixel electrode comprises a connection portion connecting to the first electrode branches.

4. The LCD panel of claim 2, wherein the first common electrode comprises a plurality of second electrode branches extending along the first direction, and each of the second electrode branches comprises the second protruding nodes.

5. The LCD panel of claim 4, wherein the first common electrode comprises a first electrode line connecting the second electrode branches.

6. The LCD panel of claim 4, wherein the second common electrode comprises a plurality of third electrode branches extending along the first direction, and each of the third electrode branches comprises the third protruding nodes.

7. The LCD panel of claim 6, wherein the second common electrode comprises a second electrode line connecting the third electrode branches.

8. The LCD panel of claim 1, wherein as viewed from above the third protruding nodes and the first protruding nodes are staggered relative to each other in an interleaved manner.

9. The LCD panel of claim 1, wherein each of the first protruding nodes comprises a first electrode portion and a pair of first bulges protrude the first electrode portion, and each of the second protruding nodes comprises a second electrode portion and a pair of second bulges protrude the second electrode portion.

10. The LCD panel of claim 9, wherein the first bulges of the first protruding nodes and the second bulges of the second protruding nodes are staggered relative to each other in an interleaved manner.

11. The LCD panel of claim 9, wherein the first protruding nodes and the second protruding nodes are polygon-shaped.

12. The LCD panel of claim 9, wherein the first protruding nodes and the second protruding nodes are hexagonally shaped.

13. The LCD panel of claim 12, wherein top surfaces of the first bulges of the hexagonally shaped first protruding nodes do not directly align with top surfaces of the second bulges of the hexagonally shaped second protruding nodes.

14. The LCD panel of claim 9, wherein the first protruding nodes and the second protruding nodes are diamond-shaped.

15. The LCD panel of claim 9, wherein the first protruding nodes and the second protruding nodes are round in shape.

16. The LCD panel of claim 9, wherein the third protruding node comprises a third electrode portion and a pair of third protruding nodes protrude from the third electrode portion.

17. The LCD panel of claim 16, wherein as viewed from above the first bulges of the first protruding nodes and the third bulges of the third protruding nodes are staggered relative to each other in an interleaved manner.

18. The LCD panel of claim 16, wherein the first protruding nodes and the third protruding nodes are hexagonally shaped.

19. The LCD panel of claim 18, wherein as viewed from above top surfaces of the first bulges of the hexagonally shaped first protruding nodes do not directly align with top surfaces of the third bulges of the hexagonally shaped third protruding nodes.

20. The LCD panel of claim 16, wherein the third protruding node is diamond-shaped.

21. The LCD panel of claim 16, wherein the third protruding node is round in shape.

22. The LCD panel of claim 1, wherein the second substrate further comprises a floating electrode interlaced with the second common electrode.

23. The LCD panel of claim 22, wherein when viewed from above the floating electrode corresponds to the pixel electrode.

24. The LCD panel of claim 22, wherein the floating electrode and the pixel electrode are of the same shape.
